(19) United States
(12) Patent Application Publication
(10) Pub. No.: US 2010/0250184 A1
(43) Pub. Date: Sep. 30, 2010

(54) ROTATION ANGLE DETECTION APPARATUS

(76) Inventors: Satoshi Kawamura, Tokyo (JP); Masahiro Iezawa, Tokyo (JP); Masaya Inoue, Tokyo (JP); Yoshitaka Onishi, Tokyo (JP); Fumitaka Takenaga, Tokyo (JP); Sotsuo Miyoshi, Tokyo (JP); Takeshi Mori, Tokyo (JP)

Correspondence Address: BIRCH STEWART KOLASCH & BIRCH, PO BOX 747, FALLS CHURCH, VA, 22040-0747, US

(21) Appl. No.: 12/746,219

(22) PCT Filed: Mar. 6, 2009
(86) PCT No.: PCT/JP2009/001025

§ 371 Date: Jun. 4, 2010

(30) Foreign Application Priority Data
Mar. 18, 2008 (JP) 2008-069525

(51) Int. Cl. G06F 19/00; G01B 21/22

(52) U.S. Cl. 702/151

(57) ABSTRACT

An arithmetic processing means detects a change in a rotation angle of one or more rotations from the direction of a change in the sign of one of sensor output signals and the sign of the other sensor output signal, and generates multiple rotation angle information from information about the detected change in the rotation angle of one or more rotations and rotation angle information about one rotation calculated from the sensor output signals.

### FIELD OF THE INVENTION

The present invention relates to a rotation angle detection apparatus particularly suitable for use in a brushless DC motor used as a driving source for driving a throttle valve used for vehicle-mounted equipment, an EGR (exhaust gas recirculation system) valve, a movable vane of a VG (Variable Geometry) turbo system, or the like.

### BACKGROUND OF THE INVENTION

A rotation angle detection apparatus uses, for example, two magnetic sensors, to input a sensor output signal which s outputted from each magnetic sensor according to the rotation angle of a rotary member, such as a brushless DC motor, to a signal processing unit, and detects the rotation angle of the rotary member by making the signal processing unit carry out a predetermined signal process.

At this time, the signal processing unit calculates the rotation angle during one rotation (360 degrees) from both a rotation angle at the time when one of the two sensor output signals crosses the zero, the two sensor output signals being outputted from the magnetic sensors according to the rotation angle of the rotary member, and being a sine wave shaped one and a cosine wave shaped one, and the sign of the other sensor output signal (for example, refer to patent reference 1).

[Patent reference 1] JP,2004-191101,A (paragraphs [0048] to [0051], and FIG. 9)

Although a rotation angle during one rotation can be detected with a high degree of accuracy according to the technology disclosed by above-mentioned patent reference 1, when the rotary member makes one or more rotations, the detection becomes very difficult because there exist two or more conditions which provide the same signal state.

Therefore, because, for example, a brushless DC motor used as a driving source for driving a throttle valve used for vehicle-mounted equipment, an EGR (exhaust gas recirculation system) valve, a movable vane of a VG (Variable Geometry) turbo system, or the like controls the open/closed state of the valve throughout the whole region during multiple rotations (e.g., two rotations), there is a problem of the degree of accuracy and it is difficult to use the conventional technology.

The present invention is made in order to solve the above-mentioned problems, and it is therefore an object of the present invention to provide a rotation angle detection apparatus which can detect a rotation angle corresponding to multiple rotations with a high degree of precision by using a rotation angle sensor which can detect one rotation.

### DESCRIPTION OF THE INVENTION

In order to solve the above-mentioned problems, a rotation angle detection apparatus in accordance with the present invention includes an arithmetic processing means for detecting a change in a rotation angle of one or more rotations from a direction of a change in a sign of one of two sensor output signals which are out of phase with each other and a sign of the other one of the two sensor output signals, and for generating multiple rotation angle information from information about the above-mentioned detected change in the rotation angle of one or more rotations and rotation angle information about one rotation calculated from the above-mentioned sensor output signals.

A rotation angle detection apparatus in accordance with the present invention includes an arithmetic processing means for generating signals of two phases each having an arbitrary number of divisions per one rotation, the signals of two phases being out of phase with each other, from rotation angle information about one rotation which is calculated from two sine wave shaped sensor output signals which are out of phase with each other, and for increasing or decreasing a number of times that the above-mentioned signals of two phases have varied according to directions of changes in the above-mentioned signals and magnitudes of the signals.

The rotation angle detection apparatus in accordance with the present invention can easily detect a rotation angle of multiple rotations with a high degree of precision by using a rotation angle sensor which can detect one rotation.

### BRIEF DESCRIPTION OF THE FIGURES

FIG. 1 is a view which is shown to explain sensors which a rotation angle detection apparatus in accordance with Embodiment 1 of the present invention uses, and its detection system;

FIG. 2 is a view showing a vector defined by two sine wave shaped sensor output signals which are out of phase with each other;

FIG. 3 is a view showing, as <table 1>, a principle underlying multiple rotation detection by the rotation angle detection apparatus in accordance with Embodiment 1 of the present invention;

FIG. 4 is a block diagram showing the configuration of internal circuits of the rotation angle detection apparatus in accordance with Embodiment 1 of the present invention;

FIG. 5 is a timing diagram showing the operation of the rotation angle detection apparatus in accordance with Embodiment 1 of the present invention in a case of normal rotation;

FIG. 6 is a timing diagram showing the operation of the rotation angle detection apparatus in accordance with Embodiment 1 of the present invention in a case of reverse rotation;

FIG. 7 is a view showing the operation of the detecting device in accordance with Embodiment 1 of the present invention, and showing a relation between a rotation number identification signal and a calculation process of calculating a rotation angle in a tabular form <table 2>;

FIG. 8 is a block diagram showing the configuration of internal circuits of a rotation angle detection apparatus in accordance with Embodiment 2 of the present invention;

FIG. 9 is a timing diagram showing the operation of the rotation angle detection apparatus in accordance with Embodiment 2 of the present invention in a case of normal rotation;

FIG. 10 is a timing diagram showing the operation of the rotation angle detection apparatus in accordance with Embodiment 2 of the present invention in a case of reverse rotation;

FIG. 11 is a view showing an example of the internal configuration of an A/B phase signal generating unit for use in the rotation angle detection apparatus in accordance with Embodiment 2 of the present invention;

FIG. 12 is a view showing a relation between changes in signals of phase A and phase B, and a change in a count value in the rotation angle detection apparatus in accordance with Embodiment 2 of the present invention in a case of normal rotation; and

FIG. 13 is a view showing a relation between changes in signals of phase A and phase B, and a change in a count value in the rotation angle detection apparatus in accordance with Embodiment 2 of the present invention in a case of reverse rotation

### PREFERRED EMBODIMENTS OF THE INVENTION

Hereafter, in order to explain this invention in greater detail, the preferred embodiments of the present invention will be described with reference to the accompanying drawings.

### Embodiment 1

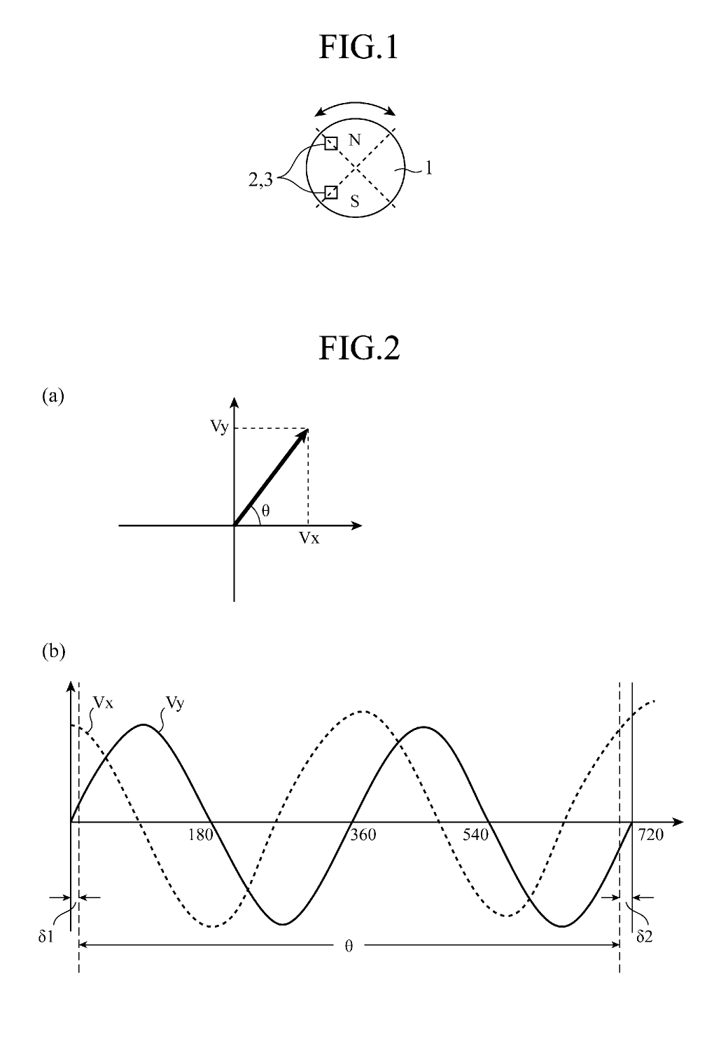

FIG. 1 is a view which is shown to explain sensors which a rotation angle detection apparatus in accordance with Embodiment 1 of the present invention uses, and its detection system.

In this embodiment, on a magnet disk 1 which rotates about an axis together with a not-shown DC motor, two Hall sensors 2 and 3 are fixedly placed at offset positions forming an angle of approximately 90 degrees from the center of the disk, and the Hall sensors construct the detection system.

As shown in FIG. 2(a), Vx and Vy which are the outputs of the Hall sensors 2 and 3 can be expressed as a vector. Actually, the sensors output sine wave shaped output signals which are out of phase with each other, as shown in, for example, FIG. 2(b). In this case, the two sensor output signals have a period of 1/n per rotation (n is an arbitrary integer).

The sensors for use in the rotation angle detection apparatus are not limited to the Hall sensors 2 and 3, and other rotation angle detection sensors, such as magnetic sensors, can be alternatively used.

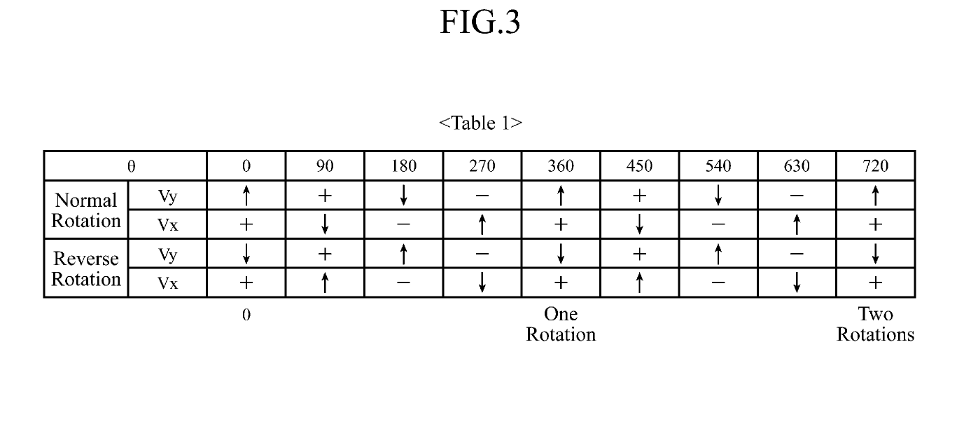

FIG. 3 is a view showing, as <Table 1>, a principle underlying multiple rotation detection for detecting a rotation angle in a case in which the rotation angle exceeds one rotation (360 degrees) by the rotation angle detection apparatus in accordance with Embodiment 1 of the present invention.

It is well known that a rotation angle of one rotation can be detected from two sensor output signals which are 90 degrees out of phase with each other. The rotation angle detection apparatus in accordance with Embodiment 1 of the present invention can detect a rotation angle of multiple rotations from the two sensor output signals which are 90 degrees out of phase with each other.

In a concrete detection principle, when the two sine wave shaped sensor output signals Vx and Vy which are out of phase as shown FIG. 2(b) are generated, a combination at the time when Vx or Vy crosses zero at 360 degrees, among combinations shown in FIG. 3 as <table 1>, is used. As a result, whether the disc has performed one or more rotations can be determined from the direction of a change in the sign of one of the two sensor output signals at the time when it crosses zero and the sign of the other sensor output signal.

For example, at the time of the 0-th rotation (0 degrees), the 1st rotation (360 degrees), and the 2nd rotation (720 degrees), the direction of a change in the sign of Vx at the time when Vx crosses zero in the case of normal rotation shows a transition from − to +, and the sign of Vy at that time is +. Furthermore, at the time of the 0-th rotation (0 degrees), the 1st rotation (360 degrees), and the 2nd rotation (720 degrees), the direction of a change in the sign of Vx at the time when Vx crosses zero in the case of reverse rotation shows a transition from + to −, and the sign of Vy at that time is −. Therefore, whether the disc has performed one or more rotations can be determined by using these combinations.

Therefore, for example, by detecting the signs and a change edge by using a comparator or the like, multiple rotation angle detection can be carried out through only arithmetic operations on binary numbers each of which is positive or negative, and a combination of pieces of hardware mainly including computing units can be configured easily. In this embodiment, this combination of pieces of hardware is generically called an arithmetic processing means.

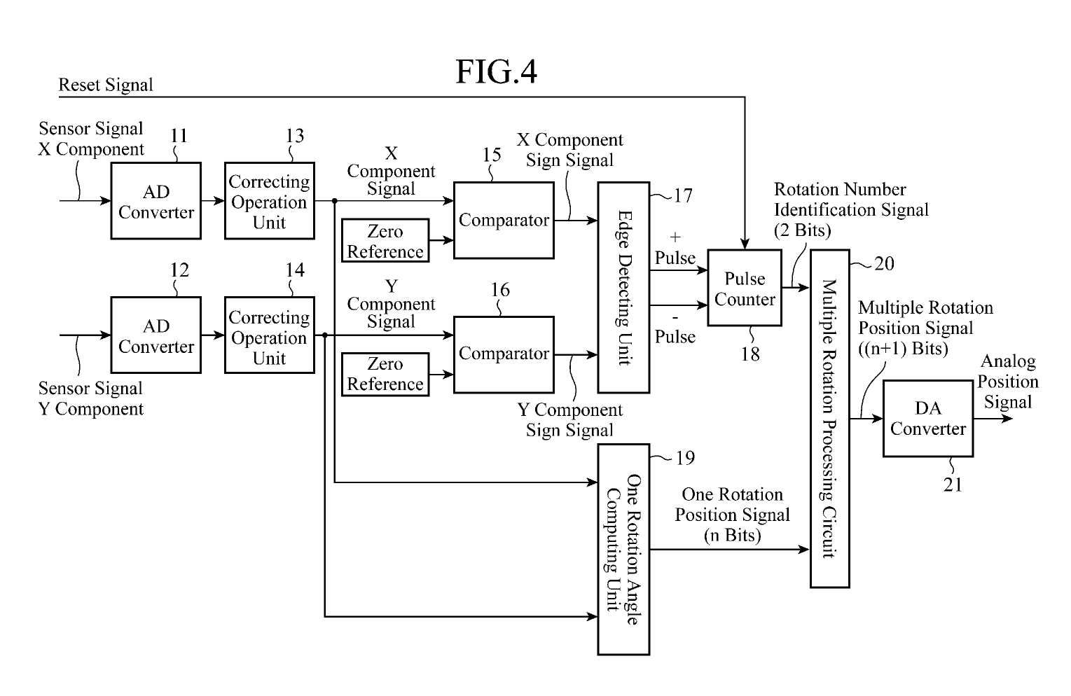

FIG. 4 is a block diagram showing an example of the configuration of internal circuits of the rotation angle detection apparatus in accordance with Embodiment 1 of the present invention.

As shown in FIG. 4, the rotation angle detection apparatus in accordance with Embodiment 1 of the present invention is provided with AD (Analog Digital) converters 11 and 12, correcting operation units 13 and 14, comparators 15 and 16, an edge detecting unit 17, a pulse counter 18, a one rotation angle computing unit 19, a multiple rotation processing circuit 20, and a DA (Digital Analog) converter 21.

The above-mentioned configuration blocks 11 to 21 operate in cooperation with one another so as to function as an arithmetic processing means for detecting a change in a rotation angle of one or more rotations from the direction of a change in the sign of one of the sensor output signals (the output signals of the Hall sensors 2 and 3) and the sign of the other one of the two sensor output signals, and for generating multiple rotation angle information from information about the detected change in the rotation angle of one or more rotations and rotation angle information about one rotation calculated from the sensor output signals. A detailed explanation of the operation will be made below.

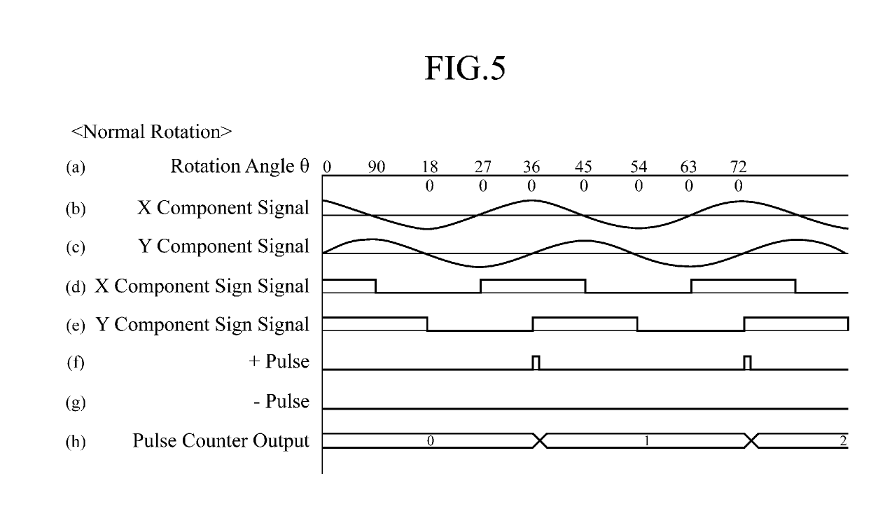

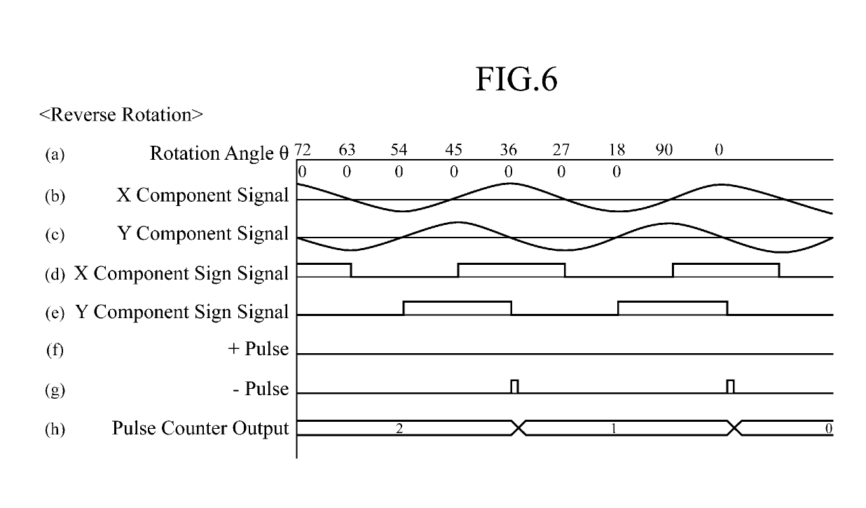

FIGS. 5 and 6 are timing diagrams showing the operation of the rotation angle detection apparatus in accordance with Embodiment 1 of the present invention, and show the operation in a case of normal rotation (FIG. 5) and the operation in a case of reverse rotation (FIG. 6). In FIGS. 5 and 6, the waveforms of signals having the same names as those shown in FIG. 4 are the same as those shown in FIG. 4, and (a) shows a rotation angle θ, (b) shows an X component signal, (c) shows a Y component signal, (d) shows an X component sign signal, (e) shows a Y component sign signal, (f) shows + pulses, (g) shows − pulses, and (h) shows the output of the pulse counter 18.

Hereafter, the operation of the rotation angle detection apparatus in accordance with Embodiment 1 of the present invention shown in FIG. 4 will be explained in detail with reference to the timing diagrams of FIGS. 5 and 6.

First, the analog signals Vx and Vy which are the two sine wave shaped sensor signals outputted by the Hall sensors 2 and 3 are converted into digital signals by the AD (Analog Digital) converters 11 and 12 respectively, and are outputted to the correcting operation units 13 and 14 respectively. The correcting operation units 13 and 14 perform corrections regarding amplitude and offset on parts to be corrected of the digital signals respectively, and furnish the corrected digital signals to the one rotation angle computing unit 19, and the one rotation angle computing unit 19 carries out a calculation of a rotation angle during one rotation and outputs the rotation angle θ (an n-bit one rotation position signal: a digital value). Because there processes are the same as those by a conventional rotation angle detection apparatus, a concrete explanation of the processes will be omitted hereafter.

The outputs of the above-mentioned correcting operation units 13 and 14 are also furnished not only to the one rotation angle computer 19, but also to first input terminals of the comparators 15 and 16, respectively. A preset zero reference value is furnished to each of second input terminals of the comparators 15 and 16, and these comparators make a comparison between the outputs of the correcting operation units and the zero reference value respectively. Each of the comparators 15 and 16 outputs a sign (signal) of “High” or “Low” to the edge detecting unit 17. The edge detecting unit 17 is configured in such a way as to, in response to the signals from the comparators 15 and 16, output a + pulse when the normal rotation conditions at 0 degrees, 360 degrees, and 720 degrees shown in the table of FIG. 3 are satisfied, and output a − pulse when the reverse rotation conditions at 0 degrees, 360 degrees, and 720 degrees are satisfied. The + pulse or − pulse generated through the detection is outputted to the pulse counter 18.

The configuration of the above-mentioned edge detecting unit 17 is shown in detail in, for example, a position detecting method using an incremental encoder shown in FIG. 6.5 of “Practice of Theory and Design on AC Servo System”, Sougosyuppansha.

The pulse counter 18 consists of 2 bits, and is configured in such a way as to, when a + pulse is outputted from the edge detecting unit 17, update its count value by +1, and, when a − pulse is outputted from the edge detecting unit 17, update its count value by −1. The count value is outputted to the multiple rotation processing circuit 20 as a rotation number identification signal.

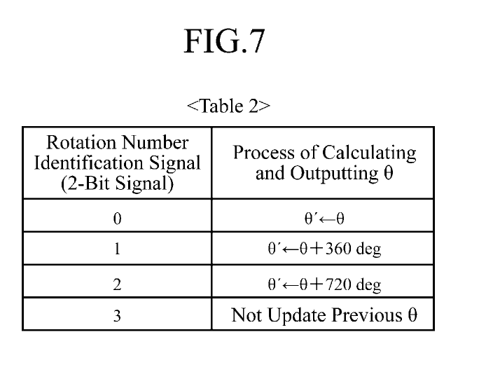

The multiple rotation processing circuit 20 is configured in such a way as to carry out a process as shown in, for example, <table 2> of FIG. 7 according to the 2-bit rotation number identification signal outputted from the pulse counter 18 to output (n+1)-bit data which is a multiple rotation position signal corresponding to an angle ranging from 0 degrees to 720 degrees to the DA converter 21, and the DA converter 21 is configured in such a way as to convert the digital signal into an analog signal and output this analog signal to a not-shown valve control system.

<Table 2> shown in FIG. 7 is a view showing a relation between the 2-bit rotation number identification signal outputted by the pulse counter 18, and the process of calculating the rotation angle θ (processing ±360 degrees of the one rotation angle signal) by the multiple rotation processing circuit 20.

The table shows that when the rotation number identification signal outputted from the pulse counter 18 is “0”, the multiple rotation processing circuit 20 outputs the rotation angle θ outputted from the one rotation angle computing unit 19 to the DA converter 21, just as it is, when the rotation number identification signal outputted from the pulse counter 18 is “1”, the multiple rotation processing circuit 20 adds 360 degrees to the rotation angle θ outputted from the one rotation angle computing unit 19 and outputs the addition result to the DA converter 21, and, when the rotation number identification signal outputted from the pulse counter 18 is “2”, the multiple rotation processing circuit 20 adds 720 degrees to the rotation angle θ outputted from the one rotation angle computing unit 19 and outputs the addition result to the DA converter 21.

In this embodiment, assuming that the whole region of the valve open or closed position is monitored during two rotations (720 degrees), when the rotation number identification signal outputted from the pulse counter 18 is “3”, the multiple rotation processing circuit 20 does not update the rotation angle θ outputted from the one rotation angle computing unit 19. In case in which the whole region of the valve open or closed position is monitored during six rotations, a three-bit signal is needed as the rotation number identification signal. By the way, this number of bits can be arbitrarily set.

As previously explained, in the above-mentioned rotation angle detection apparatus in accordance with Embodiment 1 of the present invention, the arithmetic processing means detects a change in a rotation angle of one or more rotations from the direction of a change in the sign of one of the sensor output signals and the sign of the other one of the sensor output signals, and generates multiple rotation angle information from information about the detected change in the rotation angle of one or more rotations and rotation angle information about one rotation calculated from the sensor output signals. The rotation angle detection apparatus can carry out the arithmetic operation of calculating a rotation angle of multiple rotations by using only simple hardware including a computing unit without using a large-scale circuit such as a CPU (Central Processing Unit). Therefore, the rotation angle detection apparatus can detect a rotation angle of multiple rotations by using a rotation angle sensor which can detect one rotation while being configured in a reduced size and at a low cost.

Furthermore, a method of simplifying the pulse counter 18 shown in FIG. 4 in a specific case in which the rotation range does not exceed two rotations will be explained hereafter. In the arrangement shown in FIG. 2(b), there are three times at which Vx has a + value and Vy rises: 0 degrees, 360 degrees, and 720 degrees, and the pulse counter 18 operates at each of the times. However, in the case in which the rotation range does not exceed two rotations, by making the pulse counter operate only at the position of 360 degrees, only binary information showing either 360 degrees or less or 360 degrees or more in table 2 can be provided and the pulse counter can be made to consist of 1 bit. In this case, a start point is defined as a position which is shifted forwardly by δ1 from its initial position of the full stroke and an end point is defined as a position which is shifted backwardly by δ2 from the position of 720 degrees, as shown in FIG. 2(b), so that the start and end points are shifted from their initial positions by very small amounts. Each of δ1 and δ2 has a value equal to or larger than a detection error region of the rotation detectors, and is typically equal to or larger than several degrees in a case in which the rotation detectors are simple sensors.

By setting the start and end points in this way, a time at which Vx has a + value and Vy rises occurs only once in the stroke range of 720 degrees−(δ1+δ2). Therefore, the rotation number identification signal shown in table 2 has a value of only 0 or 1, and the number of processed bits of the pulse counter 18 and that of the multiple rotation processing circuit can be reduced to 1 bit. Therefore, an advantage of being able to simplify the whole of the apparatus can be provided.

### Embodiment 2

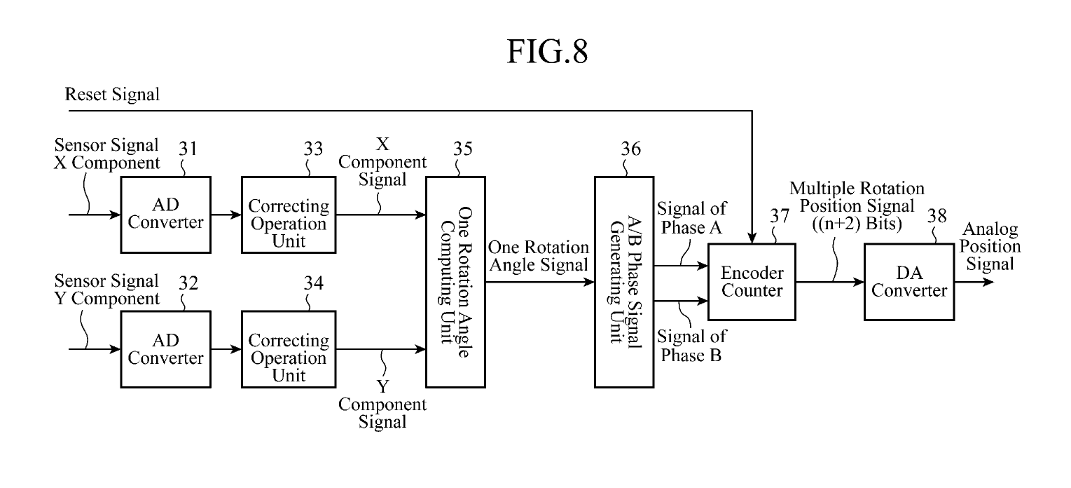

FIG. 8 is a block diagram showing the configuration of internal circuits of a rotation angle detection apparatus in accordance with Embodiment 2 of the present invention. As shown in FIG. 8, the rotation angle detection apparatus in accordance with Embodiment 2 of the present invention is provided with AD (Analog Digital) converters 31 and 32, correcting operation units 33 and 34, a one rotation angle computing unit 35, an AB phase signal generating unit 36, an encoder counter 37, and a DA converter 38.

The above-mentioned configuration blocks 31 to 38 operate in cooperation with one another so as to function as an arithmetic processing means for generating signals of two phases each having an arbitrary number of divisions per one rotation, the two phase signals being out of phase with each other, from rotation angle information about one rotation which is calculated from two sine wave shaped sensor output signals which are out of phase with each other, and for increasing or decreasing the number of times that the above-mentioned signals of two phases have varied according to the directions of changes in the signals and the magnitudes of the signals. A detailed explanation of the operation will be made below.

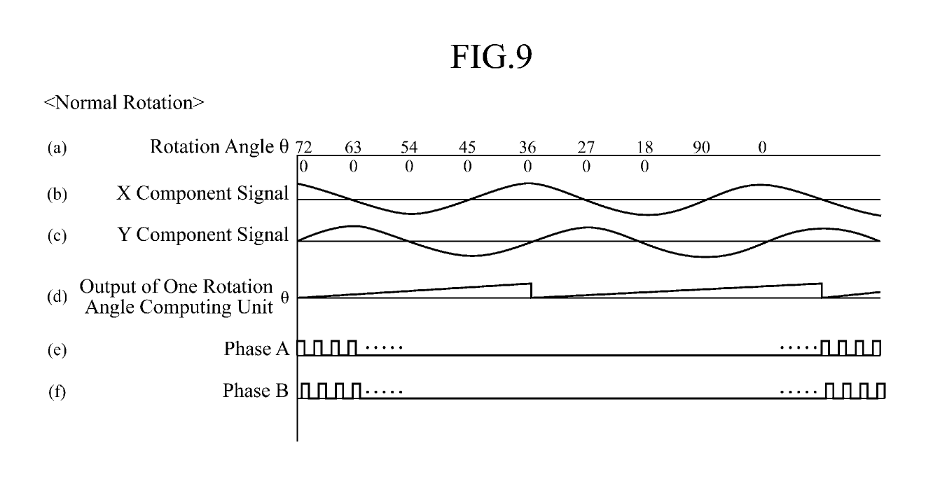

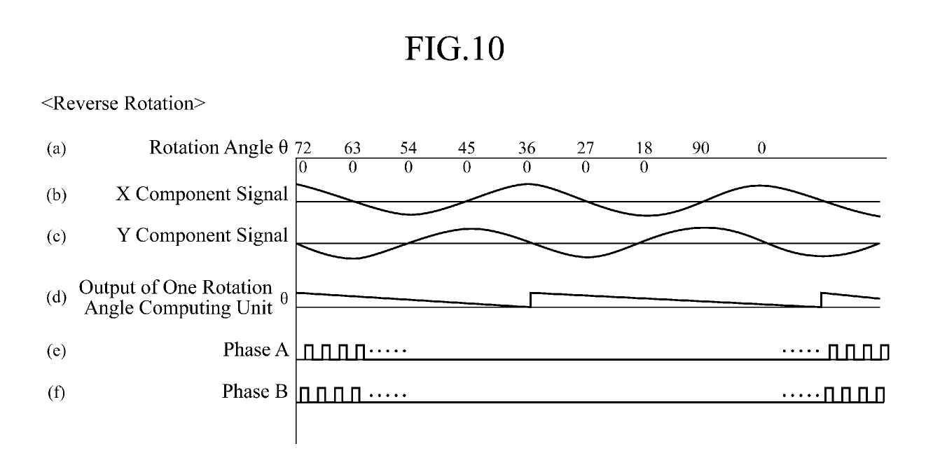

FIGS. 9 and 10 are timing diagrams showing the operation of the rotation angle detection apparatus in accordance with Embodiment 2 of the present invention, and show the operation in a case of normal rotation and the operation in a case of reverse rotation respectively. In FIGS. 9 and 10, the waveforms of signals having the same names as those shown in FIG. 8 are the same as those shown in FIG. 8, and (a) shows a rotation angle θ, (b) shows an X component signal, (c) shows a Y component signal, (d) shows an output 8 of the one rotation angle computing unit, (e) shows pulses of phase A, and (f) shows pulses of phase B.

Hereafter, the operation of the rotation angle detection apparatus in accordance with Embodiment 2 of the present invention shown in FIG. 8 will be explained in detail with reference to the timing diagrams of FIGS. 9 and 10.

First, analog signals Vx and Vy which are the two sine wave shaped sensor signals outputted by Hall sensors 2 and 3 are converted into digital signals by the AD (Analog Digital) converters 31 and 32 respectively, and are outputted to the correcting operation units 33 and 34 respectively. The correcting operation units 33 and 34 perform corrections regarding amplitude and offset on parts to be corrected of the digital signals respectively, and furnish the corrected digital signals to the one rotation angle computing unit 35, and the one rotation angle computing unit 35 carries out a calculation of a rotation angle during one rotation and outputs the rotation angle θ (an n-bit digital value). Because there processes are the same as those by a conventional rotation angle detection apparatus, a concrete explanation of the processes will be omitted hereafter.

This embodiment is characterized in that the A/B phase signal generating unit 36 generates and outputs digital signals of phase A and phase B which correspond to one rotation and 1/n (n is an arbitrary integer) of the above-mentioned rotation angle θ, and which are out of phase with each other.

The A/B phase signal generating unit 36 is comprised of, for example, a rotary encoder for outputting pulses which are out of phase with each other according to the direction of rotation. The rotary encoder generates pulses whose number differs dependently upon its resolution every time when its motor shaft rotates by a fixed amount, and information about how many degrees the shaft has moved and how many rotations the shaft has performed can be acquired by counting the pulses. However, because the direction of rotation cannot be determined from the information, the A/B phase signal generating unit outputs pulses of two phases.

For example, when the shaft rotates clockwise, the A/B phase signal generating unit outputs pulses of phase A first, and then outputs pulses of phase B while outputting the pulses of phase A. In contrast, when the shaft rotates counterclockwise, the A/B phase signal generating unit outputs pulses of phase B first, and then outputs pulses of phase A while outputting the pulses of phase B. More specifically, information about in which direction the shaft is rotating and how many amount the shaft has rotated can be acquired by using these relations.

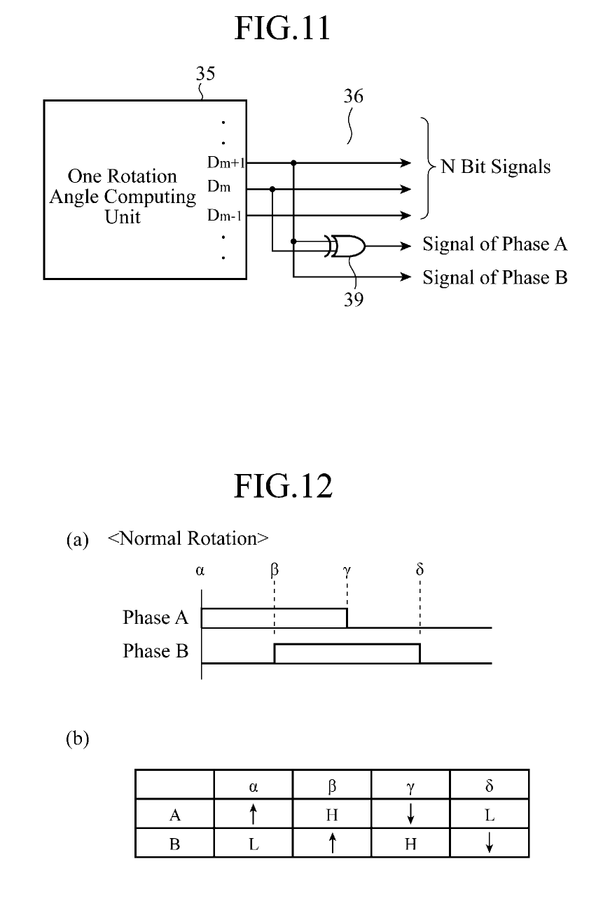

The A/B phase signal generating unit 36 generates the signals of two phases each having an arbitrary number of divisions per one rotation, the signals of two phases being out of phase with each other, from the rotation angle information about one rotation which is calculated from the two sine wave shaped sensor output signals which are out of phase with each other. The A/B phase signal generating unit 36 is comprised of a ROM (Read Only Memory) or a simple hardwired logic which is shown in FIG. 11 as an example.

For example, as shown in FIG. 11, the A/B phase signal generating unit 36 generates binary digital signals from two arbitrary contiguous bit signals (in this case, a Dm bit signal and a Dm+1 bit signal) of the rotation angle information about one rotation outputted from the one rotation angle computer 35, and outputs the binary digital signals to the encoding counter 37. In this case, the A/B phase signal generating unit implements an exclusive OR operation on the Dm bit signal and the Dm+1 bit signal to generate and output the signal of phase A to the encoder counter 37 by using an XOR gate 39, and outputs, as the signal of phase B, the Dm+1 bit signal to the encoder counter 37.

The pulses of two phases generated and outputted by the A/B phase signal generating unit 36 are counted by the encoder counter 37. The encoder counter 37 increases or decreases the number of times that the above-mentioned signals of two phases have varied according to the directions of changes in the signals of two phases generated and outputted by the A/B phase signal generating unit 36 and the magnitudes of the signals to generate multiple rotation angle information. A concrete example of the process will be explained hereafter.

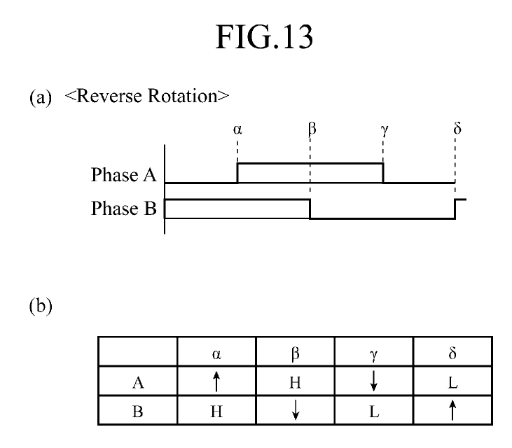

A relation between the changes of the signals of phase A and phase B and changes in the count value counted by the encoder counter 37 in a case of normal rotation, and that in a case of reverse rotation are shown in FIGS. 12 and 13 respectively. In both FIGS. 12 and 13, (a) shows the shape of a pulse of phase A and that of phase B, and (b) shows count conditions at that time.

For example, in a case in which the encoder counter 37 is updated (counted up) at each time when a pulse of phase A or a pulse of phase B changes in the case of normal rotation shown in FIG. 12(a), the pulse of phase A changes from “Low” to “High” and the pulse of phase B is at “Low” level at a change point of α, and the pulse of phase A is at “High” level and the pulse of phase B changes from “Low” to “High” at a change point of β, as shown in FIG. 12(b). Furthermore, the pulse of phase A changes from “High” to “Low” and the pulse of phase B is at “High” level at a change point of y, and the pulse of phase A is at “Low” level and the pulse of phase B changes from “High” to “Low” at a change point of δ.

As shown in FIGS. 13(a) and 13 (b), also in the case of reverse rotation, the encoder counter 37 is updated (counted down) at each of times shown by α to δ when a pulse of phase A or a pulse of phase B changes.

The encoder counter 37 counts the above-mentioned signals outputted from the A/B phase signal generating unit 36 to generate (n+2)-bit data corresponding to a range from 0 degrees to 720 degrees. The encoder counter 37 is configured in such a way as to output this data to the DA converter 38, like the multiple rotation processing unit of Embodiment 1, and the DA converter is configured in such a way as to convert the data into an analog signal and furnish this signal to a not-shown valve control system.

As mentioned above, the arithmetic control means generates signals of two phases A and B which are out of phase with each other from the rotation angle θ, and counts the signals by using the encoder counter 37. Therefore, the arithmetic control means can carry out an angle detection process of detecting multiple rotations of 360 degrees or more, and can also set an original position arbitrarily by resetting the encoder counter 37 according to an external signal generated through a switch operation or the like. As a result, there is no necessity to specially memorize the original position by using a software program or the like, and this can contribute to simplification of the software processing.

As previously explained, in the above-mentioned rotation angle detection apparatus in accordance with Embodiment 2 of the present invention, the arithmetic processing means generates signals of two phases each having an arbitrary number of divisions per one rotation, the signals of two phases being out of phase with each other, from rotation angle information about one rotation which is calculated from two sine wave shaped sensor output signals which are out of phase with each other, and for increasing or decreasing the number of times that the above-mentioned signals of two phases have varied according to the directions of changes in the signals and the magnitudes of the signals. The rotation angle detection apparatus can carry out the arithmetic operation of calculating a rotation angle of multiple rotations by using only simple hardware including a computing unit without using a large-scale circuit such as a CPU. Therefore, the rotation angle detection apparatus can detect a rotation angle of multiple rotations by using a rotation angle sensor which can detect one rotation while being configured in a reduced size and at a low cost.

Furthermore, because the arithmetic processing means defines binary digital signals as the signals of two phases generated from the rotation angle information about one rotation, each of the signals having an arbitrary number of divisions per one rotation and the signals being out of phase with each other, and further generates the binary digital signals from two arbitrary contiguous bit signals of the rotation angle information about one rotation, the rotation angle detection apparatus can carry out the acquisition of the one rotation angle signal θ and the subsequent processes by using only digital data. As a result, the rotation angle detection apparatus becomes resistant to noise, and has a low possibility of making erroneous detection due to signal noise.

### INDUSTRIAL APPLICABILITY

As mentioned above, in order to provide a rotation angle detection apparatus which can easily detect a rotation angle of multiple rotations with a high degree of precision by using a rotation angle sensor which can detect one rotation, the rotation angle detection apparatus in accordance with the present invention is constructed in such a way as to include either an arithmetic processing means for detecting a change in a rotation angle of one or more rotations from the direction of a change in the sign of one of two sensor output signals which are out of phase with each other and the sign of the other one of the two sensor output signals, and for generating multiple rotation angle information from information about the above-mentioned detected change in the rotation angle of one or more rotations and rotation angle information about one rotation calculated from the above-mentioned sensor output signals, or an arithmetic processing means for generating signals of two phases each having an arbitrary number of divisions per one rotation, the signals of two phases being out of phase with each other, from rotation angle information about one rotation which is calculated from two sine wave shaped sensor output signals which are out of phase with each other, and for increasing or decreasing the number of times that the above-mentioned signals of two phases have varied according to the directions of changes in the above-mentioned signals and the magnitudes of the signals. Therefore, the rotation angle detection apparatus is suitable for use as a rotation angle detection apparatus which can detect a rotation angle of multiple rotations while being configured in a reduced size and at a low cost, or a rotation angle detection apparatus having a low possibility of making erroneous detection due to signal noise.

1. A rotation angle detection apparatus which determines a rotation angle by using a vector from two sine wave shaped sensor output signals which are out of phase with each other, wherein said rotation angle detection apparatus comprises:
an arithmetic processing means for detecting a change in a rotation angle of one or more rotations from a direction of a change in a sign of one of said two sensor output signals and a sign of the other one of said two sensor output signals, and for generating multiple rotation angle information from information about said detected change in the rotation angle of one or more rotations and rotation angle information about one rotation calculated from said sensor output signals.

2. The rotation angle detection apparatus according to claim 1, wherein said arithmetic processing means converts said sensor output signals into digital values, compares the signals whose amplitude and offset have been corrected with a preset zero reference value to carry out edge detection, counts a pulse which is outputted on a basis of conditions of normal or reverse rotation in n rotations (n is an arbitrary integer) to use the pulse as a rotation number identification signal, and generates said multiple rotation angle information by combining with the rotation angle information about one rotation which is calculated from said sensor output signals.

3. The rotation angle detection apparatus according to claim 1, wherein when a region from a start point of an operation region to an end point of the operation region is defined as a rotation angle full stroke θ, said arithmetic processing means generates the multiple rotation angle information by defining a position which is shifted forwardly from 0 degrees by δ1 as a start point of arrangement of absolute value outputs of the sensor signals, and also defining a position which is shifted backwardly from 720 degrees by δ2 as an end point of the arrangement, setting each of δ1 and δ2 to a value equal to or larger than a rotation detection error region, and simultaneously making θ satisfy θ<720 degrees−(δ1+δ2).

4. A rotation angle detection apparatus which determines a rotation angle by using a vector from two sine wave shaped sensor output signals which are out of phase with each other, wherein said rotation angle detection apparatus comprises:
an arithmetic processing means for generating signals of two phases each having an arbitrary number of divisions per one rotation, the signals of two phases being out of phase with each other, from rotation angle information about one rotation which is calculated from said two sine wave shaped sensor output signals which are out of phase with each other, and for increasing or decreasing a number of times that said signals of two phases vary according to directions of changes in said signals and magnitudes of the signals.

5. The rotation angle detection apparatus according to claim 4, wherein said arithmetic processing means defines binary digital signals as the signals of two phases generated from said rotation angle information about one rotation, each the signals having an arbitrary number of divisions per one rotation and the signals being out of phase with each other.

6. The rotation angle detection apparatus according to claim 4, wherein said arithmetic processing means generates the binary digital signal from two arbitrary contiguous bit signals of said rotation angle information about one rotation.

7. The rotation angle detection apparatus according to claim 4, wherein said arithmetic processing means sets an original position arbitrarily according to a reset signal furnished thereto from outside the rotation angle detection apparatus.
